(19) United States
(12) Patent Application Publication
(10) Pub. No.: US 2017/0088454 A1
(43) Pub. Date: Mar. 30, 2017

(54) METHOD FOR REDUCING WARPAGE OCCURRING IN GLASS SHEET DUE TO CHEMICAL STRENGTHENING TREATMENT, METHOD FOR PRODUCING GLASS SHEET FOR CHEMICAL STRENGTHENING, AND METHOD FOR PRODUCING CHEMICALLY STRENGTHENED GLASS SHEET

(71) Applicant: Nippon Sheet Glass Company, Limited, Tokyo (JP)

(72) Inventors: Kiyomi FUKUSHIMA, Osaka (JP); Hirofumi HOTTA, Hyogo (JP)

(21) Appl. No.: 15/128,046

(22) PCT Filed: Mar. 25, 2015
(86) PCT No.: PCT/JP2015/001702

§ 371 Date: Sep. 21, 2016

(30) Foreign Application Priority Data
Mar. 27, 2014 (JP) 2014-066484

(51) Int. Cl. C03B 25/08; C03C 21/00

(52) U.S. Cl. CPC C03B 25/08; C03C 21/002; C03B 18/02

(57) ABSTRACT

The present invention is a method for reducing warpage of a glass sheet produced by a float process. This warpage occurs due to chemical strengthening treatment of the glass sheet. In the method of the present invention, a glass sheet produced by a float process is maintained in a temperature range from a temperature 70° C. lower than a strain point of the glass to a temperature 20° C. higher than the strain point for at least 10 minutes before the glass sheet is subjected to chemical strengthening treatment.

### TECHNICAL FIELD

The present invention relates to a method for reducing warpage occurring in a glass sheet due to chemical strengthening, a method for producing a glass sheet for chemical strengthening, and a method for producing a chemically strengthened glass sheet.

### BACKGROUND ART

Image displays of mobile devices such as mobile phones, smart phones, and personal digital assistants (PDAs) have a cover glass disposed thereon for surface protection. As such a cover glass, a chemically strengthened thin glass sheet with a thickness of 1.1 mm or less is commonly used.

It is known that when a thin glass sheet produced by a float process is subjected to chemical strengthening treatment, warpage occurs in the glass sheet. It is believed that this warpage is caused by the following phenomena: a difference in the amount of ions exchanged on the top surface (i.e., one surface of the glass sheet kept out of contact with molten tin during formation of the glass sheet in a float bath) and that on the bottom surface (i.e., the other surface of the glass sheet kept in contact with molten tin during formation of the glass sheet in the float bath) during chemical strengthening; and thermal deformation of the glass sheet.

Penetration of the tin component into the glass sheet through the bottom surface during formation of the glass sheet in the float bath is considered to be the major cause of the former phenomenon, i.e., a difference in the amount of exchanged ions. Therefore, polishing treatment or the like is conventionally performed to remove the penetrated tin layer. However, such treatment contributes to an increase in the production cost.

It is known that the latter phenomenon, i.e., thermal deformation of the glass sheet is classified into: deformation under residual stress generated by a difference in the cooling rate between the top surface and the bottom surface of the glass sheet, for example, during formation of the glass sheet in the float bath; and deformation of the glass sheet under its own weight when subjected to heat treatment at the strain point temperature of the glass sheet or lower. Patent Literature 1 discloses that pre-heating (preliminary heating) is performed at a temperature at least 100° C. lower than the strain point temperature before chemical strengthening treatment so as to reduce the thermal deformation of the glass under its own weight. The chemical strengthening treatment is usually performed by immersing the glass sheet in a molten salt of potassium nitrate or sodium nitrate, or a molten salt mixture thereof for a predetermined length of time. Preliminary heating is performed before the chemical strengthening treatment in order to avoid cracking of the glass sheet due to thermal shock upon contact with the molten salt used in the chemical strengthening treatment or to prevent the temperature of the molten salt from decreasing too much upon contact with the glass sheet.

### CITATION LIST

### Patent Literature

Patent Literature 1: JP 07(1995)-29170 A

### SUMMARY OF INVENTION

### Technical Problem

In the method described in Patent Literature 1, thermal deformation of the glass sheet under its own weight during chemical strengthening treatment can be reduced to some extent, but when more appropriate preliminary heating cannot be performed due to temperature limitations, etc., the glass sheet sometimes cracks due to thermal shock upon contact with the molten salt.

Furthermore, in general, when the preliminary heating for the chemical strengthening treatment is performed to reduce thermal deformation of the glass sheet under its own weight, only minimal heating required to avoid cracking of the glass sheet due to thermal shock upon contact with the molten salt can be performed. For example, the thinner the glass sheet is and the larger the size of the glass sheet is, the more the glass sheet is susceptible to deformation under its own weight when its temperature is increased before or after the chemical strengthening treatment. When chemically strengthened glass is produced in an industrial large scale, two or more glass sheets of a relatively large size with sides of 300 mm or more, for example, are placed upright in a glass holder and then a series of steps from a preliminary heating step to a chemical strengthening step are performed on the glass sheets. In this case, concerns about thermal deformation of the glass sheets under their own weight are further increased. Therefore, it is considered important not to raise the temperature too high in the preliminary heating step.

It is therefore an object of the present invention to provide a method for reducing warpage occurring in a glass sheet due to chemical strengthening treatment, by which not only warpage of a glass sheet due to chemical strengthening treatment can be reduced, even if the glass sheet is thin or large in size, but also cracking of the glass sheet due to thermal shock upon contact with a molten salt during the chemical strengthening treatment can be sufficiently reduced. It is another object of the present invention to provide a method for producing a glass sheet for chemical strengthening (i.e., a glass sheet to be subjected to chemical strengthening treatment). It is still another object of the present invention to provide a method for producing a chemically strengthened glass sheet (i.e., a glass sheet having been subjected to chemical strengthening treatment).

### Solution to Problem

The present inventors have found that warpage occurring in a glass sheet after chemical strengthening treatment can be reduced, even if the glass sheet is thin or large in size, by subjecting the glass sheet to heat treatment under certain conditions before the chemical strengthening treatment, and have arrived at the present invention. The method of the present invention disproves the common belief that preliminary heating for chemical strengthening treatment must be minimized to avoid thermal deformation, and allows warpage occurring due to chemical strengthening treatment to be reduced easily.

That is, the present invention provides a method for reducing warpage of a glass sheet produced by a float process, the warpage occurring due to chemical strengthening treatment of the glass sheet, the method including maintaining a glass sheet produced by a float process in a temperature range from a temperature 70° C. lower than a strain point of glass constituting the glass sheet to a temperature 20° C. higher than the strain point for at least 10 minutes before subjecting the glass sheet to chemical strengthening treatment.

The present invention further provides a method for producing a glass sheet for chemical strengthening, including the steps of:

(I) producing a glass sheet made of soda lime glass by a float process; and

(II) maintaining the glass sheet produced in the step (I) in a temperature range from a temperature 70° C. lower than a strain point of the glass to a temperature 20° C. higher than the strain point for at least 10 minutes.

The present invention further provides a method for producing a chemically strengthened glass sheet, including the steps of:

(i) preparing the glass sheet for chemical strengthening obtained by the method of the present invention for producing a glass sheet for chemical strengthening; and

(ii) subjecting the glass sheet for chemical strengthening to chemical strengthening treatment.

### Advantageous Effects of Invention

According to the method of the present invention for reducing warpage of a glass sheet, it is possible to reduce warpage occurring in a glass sheet due to chemical strengthening treatment, even if the glass sheet is thin or large in size, only by subjecting the glass sheet to heat treatment, in which the glass sheet is maintained in a temperature range from a temperature 70° C. lower than the strain point of the glass to a temperature 20° C. higher than the strain point for at least 10 minutes, before subjecting the glass sheet to chemical strengthening treatment. In the method of the present invention, it is only necessary to perform this heat treatment before the chemical strengthening treatment, and thus the temperature of preliminary heating for chemical strengthening treatment is not limited. Therefore, according to the method of the present invention, it is possible not only to reduce warpage occurring in a glass sheet due to chemical strengthening treatment, even if the glass sheet is thin or large in size, but also to sufficiently reduce cracking of the glass sheet due to thermal shock upon contact with a molten salt during the chemical strengthening treatment.

Furthermore, according to the method of the present invention for producing a glass sheet for chemical strengthening, it is possible not only to reduce warpage occurring in a glass sheet due to chemical strengthening treatment, even if the glass sheet is thin or large in size, but also to sufficiently reduce cracking of the glass sheet due to thermal shock upon contact with a molten salt during the chemical strengthening treatment, and thus to provide a glass sheet suitable for chemical strengthening.

Furthermore, according to the method of the present invention for producing a chemically strengthened glass sheet, it is possible to provide a chemically strengthened glass sheet with reduced cracking and with sufficiently reduced warpage, even if the glass sheet is thin or large in size.

### BRIEF DESCRIPTION OF DRAWINGS

FIG. 1 is a graph showing temperature changes in a glass sheet during heat treatment performed in Examples 1 to 14.

FIG. 2 is a graph showing temperature changes in a glass sheet during heat treatment performed in Examples 15 to 31.

### DESCRIPTION OF EMBODIMENTS

### First Embodiment

An embodiment of the method of the present invention for reducing warpage occurring in a glass sheet due to chemical strengthening treatment is described. The method of the present embodiment is a method for reducing warpage of a glass sheet produced by a float process. This warpage occurs due to chemical strengthening treatment of the glass sheet. This method includes maintaining a glass sheet produced by a float process in a temperature range from a temperature 70° C. lower than a strain point of glass constituting the glass sheet to a temperature 20° C. higher than the strain point for at least 10 minutes before subjecting the glass sheet to chemical strengthening treatment.

By subjecting a glass sheet to heat treatment, in which the glass sheet is maintained in a temperature range from a temperature 70° C. lower than the strain point of the glass of the glass sheet to a temperature 20° C. higher than the strain point for at least 10 minutes, before subjecting the glass sheet to chemical strengthening treatment, warpage occurring in the glass sheet due to the chemical strengthening treatment can be improved (which means that the warpage can be reduced). It is amazing that warpage of a chemically strengthened glass sheet is improved only by subjecting the glass sheet to this heat treatment before the chemical strengthening treatment. It is conventionally believed that heat treatment at a relatively high temperature may help increase warpage caused by chemical strengthening but cannot improve it. As a method of holding the glass sheet during the heat treatment, the glass sheet may be placed on a flat support or placed upright in a glass holder. The latter method is preferred because two or more glass sheets placed upright in a glass holder can be subjected to the treatment all at once, but the present embodiment is not limited to the latter method.

The mechanism by which warpage caused by chemical strengthening is improved has not been clearly understood, but probably the above-mentioned heat treatment relaxes the glass network to cause thermal contraction of the glass, and thereby increases the density of the glass and increases the rigidity of the glass as well. The glass having such higher rigidity is more resistant to bending stress generated in the glass sheet due to chemical strengthening. This is presumably the reason why warpage is reduced.

Here, the deflection of the glass sheet was measured before and after the heat treatment to examine a change in the rigidity of the glass by the heat treatment. The deflection measurement method is described below. As a result, the amount of deflection of the glass sheet before the heat treatment was 1.9 mm, while the amount of deflection of the glass sheet after the heat treatment was 1.6 mm. Thus, it was confirmed that the amount of deflection of the glass sheet after the heat treatment was smaller than that of the glass sheet before the heat treatment. This result indicates that the heat treatment increased the rigidity of the glass and thus increased the resistance of the glass sheet to bending deformation.

<Deflection Measurement>

(Glass Sheet Sample)

A soda lime glass sheet produced by a float process and having a rectangular shape of 200 mm in width, 300 mm in length, and 0.55 mm in thickness (having the same glass composition as that used in Examples described later) was used.

(Heat Treatment)

The glass sheet was held in a furnace at 510° C. for 90 minutes and then cooled in the air.

(Measurement)

A laser displacement sensor (“CD5A-N” manufactured by OPTEX FA Co., Ltd.) was used. The glass sheet sample was placed on a flat surface, with its four corners being supported on the surface, and the distance between the center of the glass sheet sample and the displacement sensor was measured. A weight (like a cylindrical hollow pipe) of about 130 g was placed on the center of the glass sheet sample, and the difference between the distance when the weight was placed and the distance when the weight was not placed was evaluated as the amount of displacement (amount of deflection) caused by the weight. The average of the amounts of deflection of two glass sheet samples was used as the amount of deflection for evaluation.

In the heat treatment in which the glass sheet is maintained at a temperature equal to or higher than a temperature 70° C. lower than the strain point of the glass of the glass sheet, the glass network is sufficiently relaxed, and thus the warpage due to the chemical strengthening is improved. In order to obtain higher warpage improvement effect, the temperature of the heat treatment is preferably a temperature equal to or higher than a temperature 40° C. lower than the strain point of the glass of the glass sheet, and more preferably a temperature equal to or higher than a temperature 20° C. lower than the strain point thereof. On the other hand, if the temperature of the heat treatment is too high, thermal deformation of the glass sheet under its own weight has more significant influence and thus surpasses the warpage improvement effect by the heat treatment, and as a result, the effect of improving the warpage after chemical strengthening cannot be obtained in some cases. Therefore, in the present embodiment, the temperature of the heat treatment is a temperature equal to or lower than a temperature 20° C. higher than the strain point of the glass of the glass sheet, and preferably a temperature equal to or lower than the strain point. For example, when the heat treatment is performed at a temperature range from a temperature 40° C. lower than the strain point to the strain point, the amount of warpage of a glass sheet due to chemical strengthening treatment can be minimized, even if the glass sheet is large in size, for example, having a rectangular shape with sides of 300 mm or more. Thus, the warpage can be improved more effectively.

When the glass sheet is maintained in a predetermined temperature range for at least 10 minutes in the heat treatment, the effect of improving warpage can be obtained sufficiently. However, in order to further enhance the effect of improving warpage, the length of time of maintaining the glass sheet in the temperature range is preferably at least 30 minutes, more preferably at least 60 minutes, and particularly preferably at least 90 minutes.

All that has to be done in the heat treatment is to maintain the glass sheet in the temperature range determined in the present embodiment and for the length of time determined therein. For example, the conditions such as the temperature increase rate to the predetermined temperature range and the temperature decrease rate from the predetermined temperature range are not particularly limited.

It is only necessary to perform the heat treatment before the chemical strengthening treatment. The heat treatment may be performed as a pre-heating step to be performed before the chemical strengthening treatment, or may be performed as a treatment completely different from the chemical strengthening treatment. That is, the heat treatment (including pre-heating for the chemical strengthening treatment) and the chemical strengthening treatment may be performed in this order. Alternatively, the heat treatment, pre-heating for chemical strengthening treatment, and the chemical strengthening treatment may be performed in this order.

In the method of the present embodiment, the glass sheet is produced by a float process. Therefore, warpage may occur in the glass sheet by the difference in the amount of ions exchanged during chemical strengthening treatment caused by penetration of a tin component in the bottom surface of the glass sheet during formation of the glass sheet in a float bath, as described in “BACKGROUND ART”. So, in order to reduce occurrence of warpage due to the difference in the amount of exchanged ions, polishing treatment or the like is conventionally performed to remove the penetrated tin layer. However, according to the method of the present embodiment, the rigidity of the glass is increased as described above. Therefore, warpage due to the difference in the amount of exchanged ions is less likely to occur, and as a result, the polishing amount can be reduced or the polishing treatment itself can be omitted, for example.

The glass sheet of the present embodiment is a glass sheet produced by a float process, which is a continuous glass sheet production method. In the float process, a glass material is melted in a melting furnace and the molten glass material is formed into a sheet-shaped glass ribbon on a molten metal in a float bath. The glass ribbon thus obtained is annealed in an annealing furnace and then cut into glass sheets of a predetermined size. The glass sheet of the present embodiment may be a glass sheet that is produced by a known float process. The production conditions in the float process are not particularly limited.

Soda lime glass or aluminosilicate glass, which is commonly available for use as glass for chemical strengthening, can be used for the glass sheet, and the composition of the glass is not particularly limited. However, it is preferable to apply the method of the present embodiment to glass sheets made of soda lime glass. Tin penetrates more easily into the bottom surface of a soda lime glass sheet than, for example, the bottom surface of an aluminosilicate glass sheet, during formation of the glass sheet in the float process. This is why the difference in the ion exchange rate between the top surface and the bottom surface is likely to occur. Furthermore, when soda lime glass is formed into a thin glass sheet by a float process, the top surface is more likely to have a rapidly cooled structure than the bottom surface, and thus it is easier to obtain the effect of the present invention. More specifically, since the top surface has a coarser structure than the bottom surface, when the glass sheet is subjected to heat treatment, relaxation of the glass network proceeds more rapidly in the top surface and a denser structure is formed therein than in the bottom surface. As a result, the ion exchange rate in the top surface is reduced during chemical strengthening treatment, and thus the difference in the ion exchange rate between the top surface and the bottom surface is reduced. The difference between the temperature range of the heat treatment and the temperature of the molten salt used in the chemical strengthening treatment of soda lime glass is small. Therefore, the use of such soda lime glass is advantageous from the viewpoint of heat utilization and in preventing cracking due to thermal shock when subjected to the heat treatment and subsequently to chemical strengthening treatment.

A thin glass sheet with a thickness of 1.1 mm or less is particularly susceptible to warpage after chemical strengthening. Therefore, in particular, when the method of the present embodiment is applied to a thin glass sheet with a thickness of 1.1 mm or less, remarkable effects can be obtained.

### Second Embodiment

An embodiment of the method of the present invention for producing a glass sheet for chemical strengthening and an embodiment of the method of the present invention for producing a chemically strengthened glass sheet are described.

The method of the present embodiment for producing a glass sheet for chemical strengthening includes the steps of:

(I) producing a glass sheet made of soda lime glass by a float process; and

(II) maintaining the glass sheet produced in the step (I) in a temperature range from a temperature 70° C. lower than a strain point of the glass to a temperature 20° C. higher than the strain point for at least 10 minutes.

According to this production method including the step (II), even if the glass sheet obtained in the step (II) is subjected to chemical strengthening treatment, warpage of the glass sheet thus produced is reduced. The mechanism by which warpage caused by chemical strengthening treatment following the step (II) is reduced by the step (II) is as described in the first embodiment. As a method of holding the glass sheet during the heat treatment in the step (II), the glass sheet may be placed on a flat support or placed upright in a glass holder, for example. The latter method is preferred because two or more glass sheets placed upright in a glass holder can be subjected to the treatment all at once, but the present embodiment is not limited to the latter method.

With the use of a glass sheet for chemical strengthening obtained by the method of the present embodiment for producing a glass sheet for chemical strengthening, chemical strengthening can be performed without any particular limitation to the conditions of preliminary heating for the chemical strengthening treatment. Therefore, according to the method of the present embodiment for producing a glass sheet for chemical strengthening, it is possible not only to reduce warpage occurring in a glass sheet due to chemical strengthening treatment, even if the glass sheet is thin or large in size, but also to sufficiently reduce cracking of the glass sheet due to thermal shock upon contact with a molten salt during the chemical strengthening treatment, and thus to provide a glass sheet suitable for chemical strengthening.

As described also in the first embodiment, it is also possible to produce a less warped glass sheet by performing the step (II), without performing the step of polishing the surface of the glass sheet. Therefore, the method of the present embodiment for producing a glass sheet for chemical strengthening need not include the step of polishing the surface of the glass sheet.

Furthermore, as described also in the first embodiment, it is preferable to maintain the glass sheet in a temperature range from a temperature 40° C. lower than the strain point of the glass of the glass sheet (more preferably a temperature 20° C. lower than the strain point) to the strain point for at least 10 minutes during the heat treatment of the step (II). Thus, a large-size glass sheet for chemical strengthening, for example, a glass sheet having a rectangular shape with sides of 300 mm or more, can also be produced. Preferably, the length of time during which the glass sheet is maintained at the predetermined temperature is in the same range as that described in the first embodiment.

A chemically strengthened glass sheet can be obtained by subjecting, to chemical strengthening treatment, the glass sheet for chemical strengthening produced by the method of the present embodiment for producing a glass sheet for chemical strengthening. That is, the method of the present embodiment for producing a chemically strengthened glass sheet includes the steps of;

(i) preparing the glass sheet for chemical strengthening obtained by the method of the present embodiment for producing a glass sheet for chemical strengthening; and

(ii) subjecting the glass sheet for chemical strengthening to chemical strengthening treatment.

In the method of the present embodiment for producing a chemically strengthened glass sheet, the glass sheet for chemical strengthening produced by the method of the present embodiment for producing a glass sheet for chemical strengthening is used. Therefore, chemical strengthening treatment can be performed without any particular limitation to the conditions of preliminary heating for the chemical strengthening treatment. As a result, it is possible to provide a chemically strengthened glass sheet with reduced cracking and sufficiently reduced warpage, even if the glass sheet is thin or large in size.

### EXAMPLES

Hereinafter, the present invention will be described in more detail by way of Examples. However, the present invention is not limited to the following Examples without departing from the gist of the present invention.

### Examples 1 to 14 and Comparative Examples 1 to 3

### Method for Producing Glass Sheets

Glass sheets having a thickness of 0.55 mm were produced by a float process. These glass sheets were made of soda lime glass, and their glass composition, strain point, and glass transition temperature were as shown in Table 1. A glass material prepared so as to have the glass composition shown in Table 1 was melted, and the molten glass material was formed into a glass ribbon on molten tin in a float bath. In these Examples, this glass ribbon was cut into square glass sheets of 50 mm×50 mm.

TABLE 1

| | | |
|---|---|---|
| Glass | SiO₂ | 71.5 |
| composition | Al₂O₃ | 1.7 |
| (mass %) | MgO | 4.0 |
| | CaO | 8.0 |
| | Na₂O | 13.6 |
| | K₂O | 0.9 |
| | SO₂ | 0.2 |
| | Total iron (Fe₂O₃) | 0.1 |

| | |
|---|---|
| Strain point (° C.) | 503 |
| Glass transition temperature (° C.) | 558 |

[Heat Treatment and Chemical Strengthening Treatment]

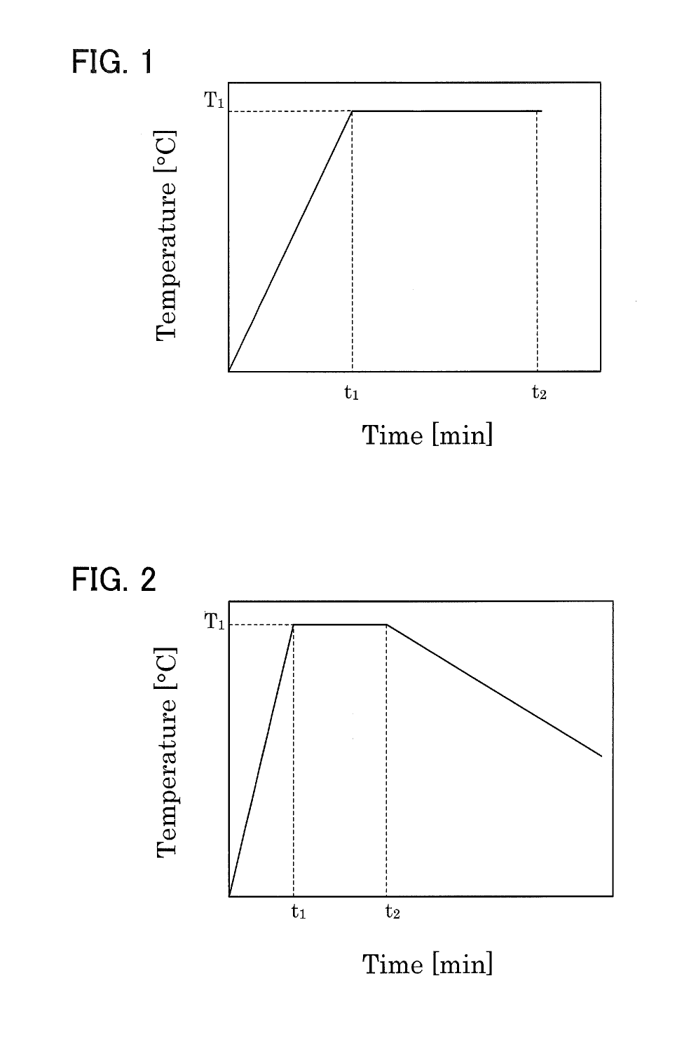

The glass sheets produced by the float process were each washed at ordinary temperature, placed upright in a glass holder, and heated in an electric furnace (“SU-2025” manufactured by Motoyama Co., Ltd.). The glass sheets, except for the glass sheet of Comparative Example 1, were heated under the conditions shown in Table 2 and FIG. 1. Each of the glass sheets was immersed in a KNO₃ molten salt at 460° C. for chemical strengthening without lowering the temperature of the heated glass sheet so as to allow ion exchange to take place for 2 hours. Only the glass sheet of Comparative Example 1 was exposed to an atmosphere at 300° C. in the furnace for 10 minutes and then ion exchange was performed. After the ion exchange, the glass sheet was exposed to an atmosphere at 300° C. for 10 minutes to remove the molten salt. Subsequently, the glass sheet was cooled in the ordinary temperature atmosphere for 10 minutes, and then washed with water at 50° C. to remove KNO₃ adhering to the glass sheet. Thus, a heat-treated and chemically strengthened glass sheet was obtained.

[Method for Measuring Amount of Warpage]

For the measurement of the amount of warpage, a non-contact three-dimensional profile measuring instrument (“NH-3N” manufactured by Mitaka Kohki Co., Ltd.) was used. Two opposite lateral sides of the chemically strengthened glass sheet were supported, with the convexly warped top surface facing upward, and the height-direction coordinate of the center of the top surface was measured. Next, the glass sheet was turned upside down, and the height-direction coordinate of the center of the top surface was measured in the same manner. One half of the two values obtained as a result of the measurement was used as the amount of warpage. The amount of warpage of the glass sheet obtained by measuring the top surface and the bottom surface thereof was that obtained by eliminating the effect of deflection under its own weight. In each Example or Comparative Example, the amounts of warpage of eight glass sheets were measured, and the average of these measurement values was used as the amount of warpage of the glass sheet of each Example or Comparative Example. Table 2 shows the results. It should be noted that the rate of improvement in the amount of warpage in each of Examples 1 to 14 and Comparative Examples 2 and 3 was calculated based on the amount of warpage in Comparative Example 1. The negative value in the rate of improvement indicates an increase in the amount of warpage.

TABLE 2

| | | | | | | | | Rate of |
|---|---|---|---|---|---|---|---|---|
| | | | | Time of | | | | improvement |
| | Thickness of | Heating | T₁ - Strain | maintenance | Temperature | Retention | Amount of | in amount of |
| | glass sheet | temperature | point | at T₁ | increase rate | time* | warpage | warpage |
| | (mm) | T₁ (° C.) | (° C.) | (min) | (° C./min) | (min) | (μm) | (%) |
| Com. Ex. 1 | 0.55 | 300 | −203 | 10 | — | — | 46 | — |
| Com. Ex. 2 | 0.55 | 430 | −73 | 60 | 6.8 | — | 45 | 2 |
| Ex. 1 | 0.55 | 450 | −53 | 60 | 7.2 | 2 | 41 | 11 |
| Ex. 2 | 0.55 | 460 | −43 | 40 | 7.3 | 4 | 38 | 17 |
| Ex. 3 | 0.55 | 470 | −33 | 120 | 7.5 | 5 | 38 | 17 |
| Ex. 4 | 0.55 | 470 | −33 | 90 | 7.5 | 5 | 33 | 28 |
| Ex. 5 | 0.55 | 470 | −33 | 60 | 7.5 | 5 | 41 | 11 |
| Ex. 6 | 0.55 | 490 | −13 | 90 | 7.8 | 7 | 29 | 37 |
| Ex. 7 | 0.55 | 490 | −13 | 60 | 7.8 | 7 | 31 | 33 |
| Ex. 8 | 0.55 | 490 | −13 | 30 | 7.8 | 7 | 36 | 22 |
| Ex. 9 | 0.55 | 490 | −13 | 10 | 7.8 | 7 | 40 | 13 |
| Ex. 10 | 0.55 | 520 | +17 | 120 | 8.3 | 10 | 38 | 17 |
| Ex. 11 | 0.55 | 520 | +17 | 90 | 8.3 | 10 | 22 | 52 |
| Ex. 12 | 0.55 | 520 | +17 | 60 | 8.3 | 10 | 33 | 28 |
| Ex. 13 | 0.55 | 520 | +17 | 30 | 8.3 | 10 | 35 | 24 |
| Ex. 14 | 0.55 | 520 | +17 | 10 | 8.3 | 10 | 38 | 17 |
| Com. Ex. 3 | 0.55 | 540 | +37 | 90 | 8.7 | 12 | 54 | −17 |

*Length of time during which the glass sheet was maintained at a temperature of 433° C. (a temperature 70° C. lower than the strain point) or higher while the temperature was increased

In all the glass sheets of Examples 1 to 14 (heating temperature: 450° C. to 520° C. (a temperature 53° C. lower than the strain point to a temperature 17° C. higher than the strain point)), the amount of warpage was smaller than that of Comparative Example 1 and a high rate of improvement in the amount of warpage was achieved. In Comparative Example 1, warpage was reduced by a conventional method in which only minimal heat treatment required to avoid cracking due to thermal shock upon immersion in the molten salt. In the glass sheet of Comparative Example 2 obtained by heat treatment at 430° C., which was 73° C. lower than the strain point, little decrease in the amount of warpage was observed after chemical strengthening, as compared with the glass sheet of Comparative Example 1. On the other hand, in the glass sheet of Comparative Example 3 obtained by heat treatment at 540° C., which was 37° C. higher than the strain point, the amount of warpage was increased. Presumably, warpage increased in the glass sheet of Comparative Example 3 because it was more significantly affected by thermal deformation under its own weight.

### Examples 15 to 31 and Comparative Examples 4 to 8

### Method for Producing Glass Sheets

Glass sheets were produced in the same manner as in Examples 1 to 14 and Comparative Examples 1 to 3, except that they had a rectangular shape of 370 mm×470 mm and a thickness of 0.4 to 0.7 mm. Table 3 shows the thicknesses of the glass sheets of Examples 15 to 31 and Comparative Examples 4 to 8.

[Heat Treatment and Chemical Strengthening Treatment]

The glass sheets of Examples 15 to 31 were subjected to heat treatment. Two or more glass sheets were placed upright in a glass holder and subjected to this heat treatment in a hot air circulation type electric furnace (a custom-made furnace with dimensions of 950 mm×950 mm×950 mm manufactured by Mizukami Electric Works Co., Ltd.). The heating conditions and others are shown in Table 3 and FIG. 2. The glass sheet was cooled to room temperature and washed at ordinary temperature. Subsequently, the glass sheet was subjected to a preliminary heating step in an atmosphere at 340° C. (a temperature 163° C. lower than the strain point) for 30 minutes and then immersed in a KNO₃ molten salt for chemical strengthening so as to allow ion exchange to take place. Table 3 shows the ion exchange conditions. After the ion exchange, the glass sheet was exposed to an atmosphere at 340° C. for 5 minutes to remove the molten salt. Subsequently, the glass sheet was cooled in an atmosphere at 200° C. for 20 minutes, and then immersed in water at 50° C. for 25 minutes and then in water at ordinary temperature for 15 minutes so as to remove KNO₃ adhering to the glass sheet. Thus, a heat-treated and chemically strengthened glass sheet was obtained. The glass sheets of Comparative Examples 4 to 8 were subjected to preliminary heating and ion exchange in the same manner as in Examples 15 to 31, without being subjected to heat treatment.

[Method for Measuring Amount of Warpage]

The chemically strengthened glass sheet was placed on a flat surface plate in such a manner that the convexly warped top surface faced downward, and the distance between the glass sheet and the flat surface plate was measured at eight points using a gap gauge. The maximum value of the distance was used as the amount of warpage of the glass sheet. For five glass sheets of each Example or Comparative Example, the amount of warpage was measured, and the average of these measurement values was used as the amount of warpage of the glass sheet of each Example or Comparative Example. Table 3 shows the results. The rates of improvement in the amount of warpage of Examples 15 to 18 were calculated based on the rate of Comparative Example 4. The rate of improvement in the amount of warpage of Example 19 was calculated based on the rate of Comparative Example 5. The rate of improvement in the amount of warpage of Example 20 was calculated based on the rate of Comparative Example 6. The rates of improvement in the amount of warpage of Examples 21 and 22 were calculated based on the rate of Comparative Example 7. The rates of improvement in the amount of warpage of Examples 23 to 31 were calculated based on the rate of Comparative Example 8.

TABLE 3

| | | | | | | | | | | | Rate of |
|---|---|---|---|---|---|---|---|---|---|---|---|
| | | Heating | T₁ - | Time of | | | | Ion exchange | | Amount | improvement |
| | Thickness of | temperature | Strain | maintenance | Temperature | Temperature | Retention | conditions | | of | in amount of |
| | glass sheet | T₁ | point | at T₁ | increase rate | decrease rate | time* | Temperature | Time | warpage | warpage |
| | (mm) | (° C.) | (° C.) | (min) | (° C./min) | (° C./min) | (min) | (° C.) | (hr) | (mm) | (%) |
| Com. Ex. 4 | 0.7 | — | — | — | — | — | — | 460 | 2 | 1.5 | — |
| Ex. 15 | 0.7 | 440 | −63 | 90 | 3.5 | 1.2 | 8 | 460 | 2 | 1.1 | 27 |
| Ex. 16 | 0.7 | 490 | −13 | 90 | 3.9 | 1.2 | 63 | 460 | 2 | 0.9 | 40 |
| Ex. 17 | 0.7 | 510 | +7 | 90 | 3.3 | 1.2 | 90 | 460 | 2 | 1.0 | 33 |
| Ex. 18 | 0.7 | 530 | +27 | 90 | 3.4 | 1.1 | 118 | 460 | 2 | 1.3 | 13 |
| Com. Ex. 5 | 0.7 | — | — | — | — | — | — | 480 | 1.2 | 1.9 | — |
| Ex. 19 | 0.7 | 510 | +7 | 90 | 3.3 | 1.2 | 90 | 480 | 1.2 | 1.0 | 47 |
| Com. Ex. 6 | 0.7 | — | — | — | — | — | — | 450 | 5 | 0.9 | — |
| Ex. 20 | 0.7 | 490 | −13 | 90 | 3.9 | 1.2 | 63 | 450 | 5 | 0.5 | 44 |
| Com. Ex. 7 | 0.4 | — | — | — | — | — | — | 460 | 0.5 | 1.2 | — |
| Ex. 21 | 0.4 | 490 | −13 | 90 | 3.9 | 1.2 | 63 | 460 | 0.5 | 0.6 | 50 |
| Ex. 22 | 0.4 | 510 | +7 | 90 | 3.3 | 1.2 | 90 | 460 | 0.5 | 0.9 | 25 |
| Com. Ex. 8 | 0.5 | — | — | — | — | — | — | 420 | 5.5 | 1.5 | — |
| Ex. 23 | 0.5 | 455 | −48 | 120 | 3.3 | 0.5 | 52 | 420 | 5.5 | 1.4 | 7 |
| Ex. 24 | 0.5 | 465 | −38 | 600 | 3.4 | 1.0 | 40 | 420 | 5.5 | 0.8 | 47 |
| Ex. 25 | 0.5 | 465 | −38 | 1080 | 3.4 | 1.6 | 30 | 420 | 5.5 | 0.7 | 53 |
| Ex. 26 | 0.5 | 475 | −28 | 120 | 3.3 | 0.9 | 58 | 420 | 5.5 | 0.8 | 47 |
| Ex. 27 | 0.5 | 485 | −18 | 600 | 3.3 | 1.5 | 51 | 420 | 5.5 | 0.7 | 53 |
| Ex. 28 | 0.5 | 485 | −18 | 600 | 3.3 | 0.5 | 120 | 420 | 5.5 | 0.5 | 67 |
| Ex. 29 | 0.5 | 485 | −18 | 1080 | 3.3 | 0.5 | 120 | 420 | 5.5 | 0.4 | 73 |
| Ex. 30 | 0.5 | 490 | −13 | 462 | 3.3 | 1.2 | 63 | 420 | 5.5 | 0.8 | 47 |
| Ex. 31 | 0.5 | 500 | −3 | 120 | 3.2 | 1.4 | 68 | 420 | 5.5 | 0.6 | 60 |

*Total length of time during which the glass sheet was maintained at a temperature of 433° C. (a temperature 70° C. lower than the strain point) or higher while the temperature was increased or decreased

All the glass sheets of Examples 15 to 31, which were subjected to the heat treatment defined in the present invention (at a heating temperature of 440° C. to 530° C. (a temperature 63° C. lower than the strain point to a temperature 27° C. higher than the strain point), exhibited high rates of improvement in the amount of warpage. Furthermore, the rate of improvement in the amount of warpage could be increased to 40% or higher by performing the heat treatment at a heating temperature ranging from a temperature 40° C. lower than the strain point to the strain point.

### INDUSTRIAL APPLICABILITY

According to the method of the present invention, it is possible to provide a glass sheet with increased strength by chemical strengthening treatment and with reduced amount of warpage even after chemical strengthening. This glass sheet is suitably used for applications that require thinness and strength, for example, for a cover glass for protecting the surface of an image display of a mobile device.

1. A method for reducing warpage of a glass sheet produced by a float process, the warpage occurring due to chemical strengthening treatment of the glass sheet, the method comprising maintaining a glass sheet produced by a float process in a temperature range from a temperature 70° C. lower than a strain point of glass constituting the glass sheet to a temperature 20° C. higher than the strain point for at least 10 minutes before subjecting the glass sheet to chemical strengthening treatment.

2. A method for producing a glass sheet for chemical strengthening, comprising the steps of:
(I) producing a glass sheet made of soda lime glass by a float process; and
(II) maintaining the glass sheet produced in the step (I) in a temperature range from a temperature 70° C. lower than a strain point of the glass to a temperature 20° C. higher than the strain point for at least 10 minutes.

3. The method for producing a glass sheet for chemical strengthening according to claim 2, wherein the method does not comprise polishing a surface of the glass sheet.

4. The method for producing a glass sheet for chemical strengthening according to claim 2, wherein
in the step (II), the glass sheet is maintained in a temperature range from a temperature 40° C. lower than the strain point of the glass to the strain point for at least 10 minutes, and
the glass sheet for chemical strengthening has a rectangular shape with sides of 300 mm or more.

5. A method for producing a chemically strengthened glass sheet, comprising the steps of:
(i) preparing the glass sheet for chemical strengthening obtained by the method according to claim 2; and
(ii) subjecting the glass sheet for chemical strengthening to chemical strengthening treatment.
